(19) United States
(12) Patent Application Publication
(10) Pub. No.: US 2007/0054100 A1
(43) Pub. Date: Mar. 8, 2007

(54) Coated paper

(75) Inventors: Tomofumi Tokiyoshi, Tokyo (JP); Fumihiko Shimizu, Tokyo (JP); Shigeru Nagashima, Amagasaki-shi (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: OJI PAPER CO., LTD., Tokyo (JP)

(21) Appl. No.: 11/516,764

(22) Filed: Sep. 7, 2006

(30) Foreign Application Priority Data
Sep. 7, 2005 (JP) 2005-259959
Mar. 3, 2006 (JP) 2006-58675

(51) Int. Cl. B41M 3/10

(52) U.S. Cl. 428/211.1

(57) ABSTRACT

The present invention provides a coated paper having, on at least one side of its base paper, two or more coating layers comprising a pigment and an adhesive as main components, said coated paper having, in its base coating layer in contact with the base paper, at least 50 parts by mass of a flat shape pigment per 100 parts by mass of the total amount of the pigments, said flat shape pigment satisfying the following conditions (1) and (2), and having a Clark stiffness along the CD direction of at least 14 cm and a white paper glossiness of at least 45%: (1) an average particle size of 0.2-5.0 μm, determined by the sedimentation method: (2) an aspect ratio (long axis/thickness) of 25-120.

### FIELD OF THE INVENTION

The present invention relates to a coated paper which is adapted to a large off-set printing machine and which does not adhere to the printing cylinder and does not form wrinkles during printing, which has an improved ink-drying property, an improved printability, a high white paper glossiness, and a base weight of not more than 80 g/m².

### BACKGROUND ART

Generally, a coated printing paper is manufactured by coating at least one side of a base paper with a coating solution comprising a pigment and an adhesive as main components, followed by drying. Coated printing papers may be divided into cast coated papers, art papers, coated papers, light-weight coated papers and the like, depending on the amount of the coating liquid to be coated and the method of finishing the coated paper. These coated papers are subjected to multi-color or mono-color printing and are widely used as commercial printed materials such as flyers, brochures and posters, or as publications such as books and magazines.

In recent years, in order to cutch a customer's attention by providing information, a growing number of direct mails are presented in illustrated and colored forms. As the postage for direct mail depends on the weight, there is a strong need for light-weight and thin coated papers, for the purpose of cost reduction. There is also a growing trend to reducing the time for delivery.

In order to increase the stiffness of a coated paper for printing, a technology of increasing stiffness by bulking has been proposed in which the density of a coated paper for printing is lowered to increase the thickness of paper. Specifically, there have conventionally been proposed methods of bulking a base paper per se by adding a bulking agent (see, Japanese Unexamined Patent Publication (Kokai) No. 2002-155494; and Japanese Unexamined Patent Publication (Kokai) No. 2003-171893), methods of treating the coating layer coated on the base paper by thermal soft calendering etc. (see, Japanese Unexamined Patent Publication (Kokai) No. 06-192996; Japanese Unexamined Patent Publication (Kokai) No. 09-228298; and Japanese Unexamined Patent Publication (Kokai) No. 06-294100), methods of using hollow plastic pigments as pigments to be blended into the coating layer (see, Japanese Unexamined Patent Publication (Kokai) No. 2002-220795; and Japanese Unexamined Patent Publication (Kokai) No. 09-119090), and the like.

Thus, the conventional proposals for bulking comprise using a relatively bulky base paper sheet as the base paper for coated paper for printing, as well as minimizing the compression pressure applied on the base paper or the coating layer when calendering the coated paper obtained by coating a coating solution on the base paper. However, the reduction in the compression pressure during calendering may deteriorate the smoothness-enhancing effect to the coating layer by the calendering process compared to when the compression pressure is not reduced and, therefore, the desired stiffness cannot be attained. A technology that can provide both the desired white paper glossiness and the desired ink-drying property has not yet been found.

### DISCLOSURE OF THE INVENTION

The present invention is intended to solve the above problems, and provides a coated paper which, when printed using a large off-set printing machine, does not adhere to the printing cylinder or form wrinkles during printing, and which has an improved printability workability, a high white paper glossiness, and a low base weight.

After intensive and extensive study to attain the above objective, the present inventors have found that a coated paper having, on at least one side of the base paper, two or more coating layers comprising a pigment and an adhesive as main components, said coated paper having a coating layer in which the pigment component of the base coating layer in contact with the base paper has at least 50 parts by mass of a flat shape pigment per 100 parts by mass of the total amount of the pigments and having a predetermined physical properties, can prevent adhesion to the printing cylinder or wrinkle formation, has a desirable ink-drying property, and can markedly improve the printability.

Thus, the coated paper as claimed in the present invention has, on at least one side of its base paper, two or more coating layers comprising a pigment and an adhesive as main components, said coated paper having, in its base coating layer in contact with the base paper, and preferably only in said base coating layer, at least 50 parts by mass of a flat shape pigment per 100 parts by mass of the total amount of the pigments, said flat shape pigment satisfying the following conditions (1) and (2), and having a Clark stiffness along the CD direction of at least 14 cm and a white paper glossiness of at least 45%:

(1) an average particle size of 0.2-5.0 μm, determined by the sedimentation method:

(2) an aspect ratio (long axis/thickness) of 25-120.

Preferably, the above flat shape pigment is an engineered kaolin. The air permeability of the above coated paper sheet is preferably not more than 7000 seconds. Furthermore, the adhesive component of the above base coating layer is preferably 5-30 parts by mass per 100 parts by mass of the total pigment component contained in the base coating layer.

The fiber orientation ratio of the above base paper is preferably 1.00-1.50 and, furthermore, the fiber orientation measured from the surface of the coated paper is 1.00-1.50. Also, the base weight of the coated paper is preferably, 35-80 g/m². In the top coating layer on the above base coating layer, it is preferred that fine particles having an average particle size of 500 nm or less are contained at 0.5 g/m² or more. It is also preferred that, in the above base coating layer, spherical particles having an average particle size of 1-50 μm are contained.

The coated paper of the present invention is characterized in that, when printed on a large off-set printing machine, it does not adhere to the printing cylinder or form wrinkles during printing, has a good ink-drying property, an improved printability, a high white paper glossiness, and a low base weight and, thus, is practically useful.

### BEST MODE FOR CARRYING OUT THE INVENTION

The flat shape pigment contained in the coating layer of the present invention preferably has an average particle size of 0.2-5.0 μm as determined by the sedimentation method, an aspect ratio (long axis/thickness) in the range of 25-120 and, more preferably, an average particle size of 0.2-4.0 μm and an aspect ratio in the range of 30-100. If the average particle size is greater than 5.0 μm or the aspect ratio is greater than 120, the CD stiffness of the resulting coated paper becomes greater, but the air resistance becomes higher and the white paper glossiness becomes lower so that the desired white paper glossiness and an air resistance of not more than 7000 seconds, preferably not more than 5000 seconds or less, and more preferably not more than 4000 seconds may not be attained. On the other hand, when the average particle size is smaller than 0.2 μm or the aspect ratio is smaller than 25, a high white paper glossiness may be obtained but the air permeability may increase and the CD stiffness may decrease.

Further, the flat shape pigment contained in the base coating layer of the coated paper of the present invention, and preferably one which is contained only in the base coating layer, has an average particle size of 0.2-5.0 μm as determined by the sedimentation method, an aspect ratio in the range of 25-120 and, more preferably, an average particle size of 0.2-4.0 μm and an aspect ration in the range of 30-100. The flat shape pigment in the above base coating layer is preferably an engineered kaolin. The degree (flatness) of a thin plate of common delaminated kaolin is generally expressed in terms of the aspect ratio (long axis/thickness), and the higher the aspect ratio, the pigment particle becomes thinner, wider, larger and more planar (with a high flatness). Though the specific numerical values of the aspect ratio are about 15-20 for commonly used delaminated kaolin, the flat shape pigment of the present invention has a flatness of about 25-120, and the aspect ratio is more preferably 30-100.

As described above, it is not known why the flat shape pigment with a high aspect ratio has an effect of enhancing the CD stiffness, but it is thought that the flat shape pigment becomes laminated to create sideways linkages and thereby enhance the stiffness.

Though it is effective in the present invention to blend the flat shape pigment specifically into the base coating layer, it is also possible to blend it into the top coating layer as long as it does not deteriorate the desired quality.

As the pigment components in the base coating layer, other pigments that can used in combination with the flat shape pigment include, for example, inorganic pigments such as calcium carbonate, kaolin, calcined kaolin, delaminated kaolin, talc, calcium sulfate, barium sulfate, aluminum hydroxide, satin white, titanium dioxide, zinc oxide, alumina, magnesium carbonate, magnesium oxide, silica, magnesium aluminosilicate, bentonite, calcium silicate, zeolite, cerilite and smectite, and organic pigments such as solid, hollow or through-hole type resins of polystyrene resins, styrene-acrylic copolymer resins, urea resins, melamine resins, acrylic resins, vinylidene chloride resins, and benzoguanamine resins. It is also possible to select one or two of them as appropriate.

The adhesive component in the above base coating layer is preferably 5-30 parts by mass per 100 parts by mass of the total amount of the pigment components contained in the base coating layer, and more preferably 7-20 parts by mass. If the adhesive component is less than 5 parts by mass, the strength of the coated layer may become so low that printing may not be carried out. On the other hand, if it is greater than 20 parts by mass, a drastic increase in air permeability may cause a reduced ink-drying property or a reduced smoothness, leading to reduced white glossiness of the coated paper sheet.

As the adhesive component in the base coating layer, there can be illustrated a conjugated dienic polymer latex such as a styrene-butadinene copolymer and a methylmethacrylate-butadinene copolymer, acrylic polymer latex, vinyl polymer latex such as such as an ethylene-vinyl acetate copolymer, and the like. One or two of the above adhesives may be used as appropriate.

Also, water-soluble adhesives may be additionally used. As the water-soluble adhesives, there can be illustrated various starches such as oxidized starch, esterified starch and cold water soluble starch, proteins such as casein, soy bean proteins and synthetic proteins, cellulose derivatives such as carboxymethyl cellulose and methyl cellulose, polyvinyl alcohols and denaturants thereof, and the like.

Spherical particles in the base coating layer preferably have an average particle size of 1-50 μm. More preferably, spherical particles having an average size greater than the thickness of the base coating layer are used. The amount of the spherical particles in the base coating layer is preferably 1-40 parts by mass per 100 parts by mass of the total amount of the pigment components. Incidentally, when the average particle size of the particles is less than 1 μm, or when they are included in an amount less than 1 part by mass, convexities are hardly formed on the surface of the coating layer, and, as the number of convexities is small, the friction coefficient of the surface of the coating layer becomes high, so that adherence between paper sheets becomes higher and double feeding at the feeding port of the printing machine may occur. When the average particle size of the particles is greater then 50 μm, or when they are included in an amount greater than 40 parts by mass, the occurrence of double feeding at the feeding port may be avoided because of reduced adherence, but the white paper glossiness may decrease.

Among the spherical particles for use in the present invention, there can be illustrated, as the inorganic pigments, precipitated calcium carbonate, magnesium carbonate and the like, and one or two among them are selected as appropriate and used.

Among the spherical particles for use in the present invention, there can be illustrated, as the solid, hollow and through-hole organic pigments, polystyrene resins, styrene-acrylic copolymer resins, urea resins, melamine resins, acrylic resins, vinylidene chloride resins, benzoguanamine resins and the like, and one or two among them may be selected as appropriate and used. Also, inorganic pigments and organic pigments may be used in combination.

Though the spherical particles for use in the present invention are characterized by being blended into the base coating layer, it is also possible to blend it into the top coating layer as long as it does not deteriorate the desired quality.

The base coating layer of the coated paper sheet of the present invention can be formed by applying it on one side or both sides of the base paper, followed by drying. Coating methods that can be adopted include roll coating, air-knife coating, bar coating, blade coating, spray coating, curtain coating, die coating and the like. The coating amount is selected from the range of 2-10 g/m² per one side of the base paper. The smoothness of the base coating layer is preferably adjusted to be in the range of 30-500 seconds.

When blade coating is used in forming the top coating layer described below, streaks or scratches may occur if the smoothness of the base coating layer exceeds 500 seconds. However, if the smoothness of the base coating layer is less than 500 seconds, the occurrence of streaks or scratches can be completely prevented.

The top coating layer of the coated paper as claimed in the present invention is formed by applying a coating solution for the top coating layer comprising 1-20 parts by mass of an adhesive per 100 parts by mass of the total amount of the pigments together with an organic pigment or an inorganic pigment with an average particle size in the range of 0.01-3 μm, preferably 0.01-1.0 μm, alone or in combination, to the surface of the base coating layer formed on the base paper, followed by drying. Coating methods that can be adopted include roll coating, air-knife coating, bar coating, blade coating, spray coating, curtain coating, die coating and the like. The coating amount on the top coating layer should be less than the coating amount on the base coating layer described above, and is selected from the range of 0.5-8 g/m² per one side.

The reason why the average particle sizes of the organic pigments and inorganic pigments contained in the top coating layer are defined as described above is to obtain the desired white glossiness and the desired air resistance. If the coating amount exceeds the range described above, the air resistance may increase and air permeability may deteriorate. On the other hand, if the coating amount is less than the above amount, the targeted glossiness may not be obtained.

As the inorganic pigment for use in the top coating layer, there can be used, for example, calcium carbonate, calcined kaolin, engineered kaolin, delaminated kaolin, talc, calcium sulfate, barium sulfate, aluminum hydroxide, satin white, titanium dioxide, zinc oxide, alumina, magnesium carbonate, magnesium oxide, silica, magnesium aluminosilicate, bentonite calcium silicate, zeolite, cerilite and smectite. As the organic pigments, there can be used, for example, solid and hollow and through-hole type resins of polystyrene resins, styrene-acrylic copolymer resins, urea resins, melamine resins, acrylic resins, vinylidene chloride resins and benzoguanamine resins. It is also possible to select one or two among them as appropriate and to use them. Furthermore, after intensive and extensive study on the development of glossiness, it was found to be specifically desirable to blend fine particles of plastic pigments or binder pigments with a particle size of 500 nm or less. The amount blended of the fine particles is preferably at least 50% by mass of the top coating layer.

As the adhesive component in the top coating layer, similarly to the base coating layer described above, there can be illustrated, for example, a conjugated dienic polymer latex such as a styrene-butadinene copolymer and a methylmethacrylate-butadinene copolymer, an acrylic polymer latex and vinyl polymer latex such as such as an ethylene-vinyl acetate copolymer and the like. Also, water-soluble adhesives may be used in combination. As the water-soluble adhesives, there can be illustrated various starches such as oxidized starch, esterified starch and cold water soluble starch, proteins such as casein, soy bean proteins and synthetic proteins, cellulose derivatives such as carboxymethyl cellulose and methyl cellulose, polyvinyl alcohols and denaturants thereof and the like. One or two may be used as the adhesive component in the top coating layer.

To the coating solution for use in forming the base coating layer and the coating solution for use in forming the top coating layer, each as desired, there can be blended, as appropriate, various additives such as bluish or purplish dyes, colored pigments, fluorescent dyes, thickening agents, water retention agents, antioxidants, anti-aging agents, conduction-inducing agents, anti-foaming agents, ultraviolet absorbing agents, dispersants, pH adjusting agents, release agents, water resistant additives and water repellents.

The coating paper on which the coating solution for forming the top coating layer is coated, is subjected to a finishing process. In this process, for example, supercalender, gloss calender, soft calender or the like can be employed, and inter alia, it is preferable to employ a calender provided with a rigid resin-roller.

In accordance with the present invention, the average particle size of the respective pigment component contained in the base coating layer and the top coating layer is specified, and the base coating layer and the top coating layer are prepared on one side or both sides of the base paper, so that coated paper for printing with a density of at least 1.10 g/cm³ can be obtained by a calendering process conventionally used in the art, unless a specifically high compression force is adopted.

When the stiffness of the coated paper as claimed in the present invention is less than 14 cm, the paper may tend to adhere onto the roll at the fixing region due to the heat, when fixing is conducted in the printing machine or the dry electronphotography system, and this may lead to defective travelling. Also, when the white paper glossiness of the surface is less than 45%, a difference in glossiness between image part and non-image part is significant, and high quality images having the desired glossiness of the present invention may not be obtained.

The moisture content of the coated paper as claimed in the present invention is generally adjusted to a range of 3-10%. More preferably it is in the range of 4-8%. When the moisture content cannot attain the range of 3-10%, curling may occur in the coated paper, and stable printing cannot be secured.

The base weight of the coated paper as claimed in the present invention is 35-80 g/m², preferably 45-75 g/m², and when the base weight is lower than 35 g/m², winkle formation, due to the dampening solution used during printing, becomes significant. Thus, after intensive and extensive study on the prevention of wrinkle formation due to the dampening solution used during printing, it was found that wrinkle formation can be prevented by adjusting the fiber orientation ratio of the base paper to preferably 1.00-1.50, more preferably 1.00-1.40. Specific procedures include, for example, adjustment of the machine conditions such as the jet/wire ratio or shaking condition (particularly, use of a Duo Shake system is preferable) of the paper machine, adjustment of drying conditions (draw during drying, drying moisture etc.). When the fiber orientation ratio of the base papers exceeds 1.50, the CD stiffness of the coated paper may become smaller, and hence wrinkles may be formed due to the dampening solution during printing. Even when the fiber orientation ratio is similarly measured from the surface of the coated paper, the fiber orientation ratio is preferably 1.00-1.50, more preferably 1.00-1.40.

For the pulp of the base paper, the manufacturing method, the type etc. are not specifically limited, and there can be used chemical pulp such as KP, mechanical pulps such as SGP, RGP, BCTMP and CTMP, recycled paper pulp such as deinked pulp, non-wood pulp such as kenaf, bamboo, straw and hemp, organic synthetic fibers such as polyamide fiber, polyester fiber and polynosic fiber, and furthermore inorganic fibers such as glass fiber, ceramic fiber and carbon fimber. Also, chlorine-free pulp such as ECF pulp and TCF pulp is preferably used. Furthermore, from the viewpoint of environmental protection, it is preferred to use pulp obtained from the so-called certified wood that was certified as forest, plantation tree chips or thinned wood chips.

In the base paper, fillers may be blended as needed. The fillers in this case include, but are not limited to, various pigments commonly used for high-quality paper, for example mineral pigments such as kaolin, calcined kaolin, calcium carbonate, calcium sulfate, barium sulfate, titanium dioxide, talc, zinc oxide, alumina, magnesium carbonate, magnesium oxide, silica, white carbon, bentonite, zeolite, cerilite and smectite, and organic pigments such as polystyrene resins, urea resins, melamine resins, acrylic resins and vinylidene chloride resins, and hollow and through-hole type resins thereof.

In addition to pulp fibers and fillers in the paper material, as needed, there can be selected, as long as the desired effect of the present invention is not ruined, various conventionally-used internal auxiliary agents for paper making materials such as various anionic, nonionic, cationic or amphoteric retention aids, drainage-enhancing agents, paper strength-enhancing agents and internal sizing agents. Furthermore, internal auxiliary agents for paper making such as dyes, fluorescent brightening agents, pH-adjusting agents, anti-foaming agents, pitch controlling agents and slime controlling agents may be added as appropriate depending on the use of the paper.

The method of making the paper is not specifically limited, and any papermaking method can be adopted, for example an acid papermaking method in which pH of papermaking is about 4.5, and a neutral papermaking method which contains an alkaline filler such as calcium carbonate as the main component and in which the papermaking pH is a weak acid pH of about 6 to a weak alkaline pH of about 9, and also paper machines such as the Fourdrinier paper machine, the twin wire paper machine, the cylinder paper machine and the Yankee paper machine can be used as appropriate. The base weight of the base paper sheet obtained is preferably 30-75 g/m².

The coated paper obtained by the method described above can be used as a paper sheet for offset printing, and can also be used, due to the high smoothness and high air permeability of the surface, as image recording paper sheets for nonimpact printing such as the electrophotographic method and the thermal transfer method etc.

In the above image recording, specifically in the electrophotographic method in which images are formed by toner particles of about 5-7 μm, extremely high quality images can be obtained by using the above coated papers. For example, when images are formed and evaluated according to a method pursuant to the ISO-13660 Draft Standard QEA (Quality Engineering Associates, Inc.) using an electrophotographic printer, mottles in the tile size 40 μm are 10 GSV (Grey Scale Value) or less, and the raggedness (degree of serration) of the line is 10 μm or less and blurriness (degree of fuzzy) is 11 μm or less, and thus very good images can be obtained.

### EXAMPLES

The present invention will now be specifically explained with reference to Examples, but the present invention is not limited to the Examples in any way. Unless otherwise specified, parts and % in the Examples refer to parts by mass and % by mass, respectively.

### Example 1

Preparation of the Base Coating Liquid

A pigment slurry was prepared by mixing an aqueous solution in which 0.1 part of sodium polyacrylate as the dispersant relative to 100 parts of dispersed engineered kaolin and 100 parts of engineered kaolin (trade name: Contour 1500, average particle size: 0.46 μm, aspect ratio: 59, manufactured by Imerys) as the flat shape pigment, and by dispersing the resultant mixture with a Cowless dissolver. To the slurry were added, relative to 100 parts of the pigment, 4.0 parts of an oxidized starch (trade name: ACE A, manufactured by OJI CORN STARCH K.K.), 10 parts of a styrene-butadiene copolymer latex (trade name: 2531-H, manufactured by JSR), and, as auxilliary agents, an anti-foaming agent and a dye to prepare a coating solution having a final solid concentration of 50%.

[Preparation of Top Coating Liquid]

To a plastic pigment in a slurry form (trade name: POT7099, average particle size: 60 nm, manufactured by Zeon Corporation) relative to 100 parts of the pigment, 2 parts of an oxidized starch (trade name: OJI ACE A, manufactured by OJI CORN STARCH K.K.), 5 parts of a styrene-butadiene copolymer latex (trade name: 2531-H, manufactured by JSR), and, as auxilliary agents, an anti-foaming agent and a dye were added to prepare a coating solution having a final solid concentration of 40%.

[Preparation of Coated Paper]

A fine base paper (base weight: 50 g/m² ) having a fiber orientation ratio of 1.30 and a density of 0.75 g/cm³ was made by adjusting the ratio of the feed jet speed from the inlet/the wire rate (hereinafter referred to as J/W). On both sides of this base paper, the above base coating solution was coated using a blade coater to a dry weight per side of 5 g/m² and dried to prepare an base coating layer. Then, on the base coating layer, the above top coating solution was coated using a blade coater to a dry weight per side of 2 g/m² and dried to prepare a top coating layer. The coated paper thus obtained was subjected to supercalendering at 35° C. and a nip pressure of 80 KN/m to obtain a coated paper with a bulk density of 1.00 g/cm³.

### Example 2

A coated paper was obtained in a similar manner to Example 1, except that the base weight of the base paper used in Example 1 was changed to 46 g/m² and the coating amount of the base coating solution was changed to 7 g/m².

### Example 3

A coated paper was obtained in a similar manner to Example 1, except that the base weight of the base paper used in Example 1 was changed to 54 g/m² and the coating amount of the base coating solution was changed to 3 g/m².

### Example 4

A coated paper was obtained in a similar manner to Example 1, except that the fiber orientation ratio of the base paper used in Example 1 was changed to 1.50 by adjusting J/W.

### Example 5

A coated paper was obtained in a similar manner to Example 1, except that the top coating pigment used in Example 1 was changed to kaolin (trade name: Kaogloss, 0.4 μm, manufactured by HUBER).

### Example 6

A coated paper was obtained in a similar manner to Example 1, except that the plastic pigment having a particle size of 60 nm (trade name: POT7099, manufactured by Zeon Corporation) as the pigment for the top coating layer was replaced with a binder pigment (trade name: S2577A, manufactured by JSR) having a particle size of 250 nm.

### Example 7

A coated paper was obtained in a similar manner to Example 1, except that the coating amount of the top coating layer was changed to 0.5 g/m² and the base weight of the base paper was changed to 53 g/m².

### Example 8

A coated paper was obtained in a similar manner to Example 1, except that the base weight of the base paper used in Example 1 was changed to 48 g/m², the coating amount of the top coating layer was changed to 3.0 g/m², and the pigment of the base coating layer was changed to an engineered kaolin (trade name: Contour Xtreme, average particle size: 0.26 μm, aspect ratio: 33, manufactured by Imerys).

### Example 9

A coated paper was obtained in a similar manner to Example 1, except that the engineered kaolin (trade name: Contour 1500, average particle size: 0.46 μm, aspect ratio: 59, manufactured by Imerys) used in Example 1 was changed to 90 parts and the spherical particle (particle size: 10 μm, precipitated calcium carbonate, manufactured by KOMESHO SEKKAI KOGYO CO., LTD.) was changed to 10 parts.

### Comparative Example 1

A coated paper was obtained in a similar manner to Example 1, except that the pigment component of the base coating solution in Example 1 was changed to a delaminated kaolin (trade name: Capim NP, average particle size: 0.75 μm, aspect ratio: 20, manufactured by Imerys).

### Comparative Example 2

A coated paper was obtained in a similar manner to Example 1, except that the pigment component of the base coating solution in Example 1 was changed to a kaolin (trade name: Capim DG, average particle size: 0.6 μm, aspect ratio: 11, manufactured by Imerys).

### Comparative Example 3

A coated paper was obtained in a similar manner to Example 1, except that the pigment component of the top coating solution in Example 1 was changed from the plastic pigment having a particle size of 60 nm (trade name: POT7099) to a plastic pigment (trade name: AE851) having a particle size of 1 μm.

Evaluation of Quality of the Coated Paper

The quality of each coated paper obtained in Examples 1-9 and Comparative Examples 1-3 was evaluated in the following items. Evaluation was carried out at an environment of 23° C. and 50 RH %, unless otherwise specified. The results are shown in Tables 1-3.

[Measurement of the Average Particle Size of the Pigment by the Sedimentation Method]

Using the SediGraph 5100 manufactured by Micromeritix of the USA, the particle-size distribution of the pigment was measured to obtain the average particle size corresponding to cumulative 50% by mass. The pigment-dispersant subjected to measurement was obtained by adding a dispersing agent (sodium polyacrylate) at 0.05% relative to the pigment to prepare a pigment slurry and then by diluting the resultant slurry with a 0.1% aqueous solution of a phosphate dispersant (Nankarin) to a pigment solid concentration of 5%.

[Measurement of the Aspect Ratio and Observation of the Shape of the Pigment]

An electron microscope was used at a magnification of 15,000 to measure the aspect ratio and observe the pigment shape.

[Density]

The bulk densities of the calendered coated paper and the base paper were measured in accordance with ISO534:1988.

[Measurement of Glossiness of the Coated Paper]

The glossiness of the coated paper was measured at an angle of incidence of 75 degrees and a receiving light angle of 75 degrees, in accordance with TAPPI testing method: T 480 om-92. Measuring instrument: Trade name GLOSS METER MODEL GM-26D (manufactured by MURAKAMI SHIKISAI KENKYUSHO).

[Measurement of Air Resistance of the Coated Paper Sheet]

It was measured using the Oken type air resistance meter.

[Measurement of CD Stiffness of Paper]

The stiffness of the coated paper in cross direction (CD) of the sheet was measured by using a Clark stiffness tester in accordance with TAPPI T451.

[Measurement of the Fiber Orientation Ratio]

An ultrasound propagation velocity meter (model SST: Sonic Sheet Tester, manufactured by Nomura Shoji) was used as the instrument for measuring fiber orientation.

[Measurement of the Convex Portions on the Surface of the Coated Paper]

An electron microscope was used at a magnification of 100 to measure the convex portions on the surface of the coated layer, and the result was expressed in terms of the number of convex portions per square mm.

[Printing of the Coated Paper]

A lithographic printer (model: Dia 4E4 type) manufactured by Mitsubishi was used for printing with a printing ink (trade name: Values-G, black, type S, manufactured by Dainippon Ink and Chemicals Incorporated) at a printing speed of 8000 sheets/hour.

[Evaluation of Travelling Performance During Printing]

Excellent: Occurrence of adhering to the blanket: 0 times, practically insignificant, excellent

Good: Occurrence of adhering to the blanket: 1-3 times, practically insignificant

Fair: Occurrence of adhering to the blanket: 4-10 times, practically significant

Failure: Occurrence of adhering to the blanket: 11 times or more, practically significant, markedly inferior.

[Evaluation of the Ink-Drying Property]

By attaching a woodfree paper on the printed surface one hour after printing, ink transfer was evaluated according to the following evaluation criteria.

Excellent: No ink transfer is noted, practically insignificant, excellent

Good: Slight ink transfer is noted, practically insignificant

Fair: Frequent ink transfer is noted, practically significant

Failure: Marked ink transfer is noted, practically significant, markedly inferior.

[Evaluation of Occurrence of Wrinkle Formation in the Sample after Printing]

Excellent: No occurrence of wrinkle formation, excellent

Good: Slight occurrence of wrinkle formation is noted, but practically insignificant

Fair: Occurrence of wrinkle formation is noted, practically significant

Failure: Marked occurrence of wrinkle formation is noted, practically significant.

TABLE 1

| | | | Particle | Aspect |
|---|---|---|---|---|
| Trade name | Component | Shape | size μm | ratio |
| Contour | Engineered | Hexagonal | 0.46 | 59 |
| 1500 | kaolin | disc | | |
| Contour | Engineered | Hexagonal | 0.26 | 33 |
| Xtreme | kaolin | disc | | |
| CapimNP | Delaminated | Hexagonal | 0.75 | 20 |
| | kaolin | disc | | |
| CapimDG | Kaolin | Hexagonal | 0.60 | 11 |
| | | disc | | |

TABLE 2

| | | | | | White-paper quality | | | | | |
|---|---|---|---|---|---|---|---|---|---|---|
| | Base coating layer | | Top coating layer | | | | | Fiber orientation | | |
| | | Amount | | Amount | | Air | CD | ratio | | No. of |
| | | coated | | coated | Glossiness | resistance | stiffness | Base | Coated | Convexity |
| | Material | g/m² | Material | g/m² | % | Seconds | cm | paper | paper | No./mm2 |
| Ex. 1 | Contour 1500 | 5 | POT7099 | 2 | 60 | 2500 | 16.0 | 1.30 | 1.25 | 0 |
| Ex. 2 | Contour 1500 | 7 | POT7099 | 2 | 60 | 3500 | 17.0 | 1.30 | 1.25 | 0 |
| Ex. 3 | Contour 1500 | 3 | POT7099 | 2 | 60 | 2000 | 14.0 | 1.30 | 1.25 | 0 |
| Ex. 4 | Contour 1500 | 5 | POT7099 | 2 | 60 | 2500 | 15.0 | 1.50 | 1.35 | 0 |
| Ex. 5 | Contour 1500 | 5 | POT7099 | 2 | 50 | 3000 | 16.0 | 1.30 | 1.26 | 0 |
| Ex. 6 | Contour 1500 | 5 | S2577A | 2 | 70 | 3500 | 16.0 | 1.30 | 1.25 | 0 |
| Ex. 7 | Contour 1500 | 5 | POT7099 | 0.5 | 48 | 1700 | 16.6 | 1.30 | 1.25 | 0 |
| Ex. 8 | Contour Xtreme | 5 | POT7099 | 3 | 60 | 2500 | 15.0 | 1.30 | 1.25 | 0 |
| Ex. 9 | Contour 1500 + 10μ | 5 | POT7099 | 2 | 55 | 2000 | 15.5 | 1.30 | 1.25 | 300 |
| | spherical | | | | | | | | | |
| | particles | | | | | | | | | |
| Com. | CapimNP | 5 | POT7099 | 2 | 60 | 3500 | 12.0 | 1.30 | 1.26 | 0 |
| Ex. 1 | | | | | | | | | | |
| Com. | CapimDG | 5 | POT7099 | 2 | 60 | 8000 | 11.0 | 1.30 | 1.24 | 0 |
| Ex. 2 | | | | | | | | | | |
| Com. | Contour 1500 | 5 | AE851 | 2 | 30 | 8000 | 16.0 | 1.30 | 1.24 | 0 |
| Ex. 3 | | | | | | | | | | |

TABLE 3

| | Travelling performance | | |
|---|---|---|---|
| | Adhesion to | Ink-drying | |
| | the cylinder | propery | Wrinkle |
| Ex. 1 | Good | Excellent | Excellent |
| Ex. 2 | Excellent | Good | Excellent |
| Ex. 3 | Good | Excellent | Excellent |
| Ex. 4 | Good | Excellent | Good |
| Ex. 5 | Good | Good | Excellent |
| Ex. 6 | Good | Excellent | Excellent |
| Ex. 7 | Good | Excellent | Excellent |
| Ex. 8 | Good | Excellent | Excellent |
| Ex. 9 | Good | Excellent | Excellent |
| Comp. Ex. 1 | Failure | Good | Good |
| Comp. Ex. 2 | Failure | Failure | Good |
| Comp. Ex. 3 | Failure | Failure | Good |

### INDUSTRIAL APPLICABILITY

The coated paper, as claimed in the present invention and when printed using a large off-set printing machine, does not adhere to the printing cylinder and does not form wrinkles during printing, and has a good ink-drying property, an improved printability, a high white paper glossiness, a base weight of 80 g/m² or less, and is practically very useful.

1. A coated paper having, on at least one side of its base paper, two or more coating layers comprising a pigment and an adhesive as main components, said coated paper having, in its base coating layer in contact with the base paper, at least 50 parts by mass of a flat shape pigment per 100 parts by mass of the total amount of the pigments, said flat shape pigment satisfying the following conditions (1) and (2), and having a Clark stiffness along the CD direction of at least 14 cm and a white paper glossiness of at least 45%:
(1) an average particle size of 0.2-5.0 μm, determined by the sedimentation method:
(2) an aspect ratio (long axis/thickness) of 25-120.

2. The coated paper according to claim 1, wherein said flat shape pigment is an engineered kaolin.

3. The coated paper according to claim 1, wherein the air resistance of said coated paper sheet is not more than 7,000 seconds.

4. The coated paper according to claim 1, wherein the adhesive component of said base coating layer is 5-30 parts by mass per 100 parts by mass of the pigment component contained in the base coating layer.

5. The coated paper according to claim 1, wherein the fiber orientation ratio of said base paper is 1.00-1.50.

6. The coated paper according to claim 1, wherein the fiber orientation ratio measured from the surface of the coated paper is 1.00-1.50.

7. The coated paper according to claim 1, wherein the base weight of the coated paper sheet is 35-80 g/m².

8. The coated paper according to claim 1, wherein fine particles having an average particle size of 500 nm or less are contained at 0.5 g/m² or greater in the top coating layer on said base coating layer.

9. The coated paper according to claim 1, wherein spherical particles having an average particle size of 1-50 μm are contained in said base coating layer.
